(19) United States
(12) Patent Application Publication
(10) Pub. No.: US 2006/0242318 A1
(43) Pub. Date: Oct. 26, 2006

(54) Method and apparatus for cascading media

(76) Inventors: Paul Nettle, Plano, TX (US); Christopher Walden, Plano, TX (US)

Correspondence Address: VERNON E. WILLIAMS P.C., P.O. BOX 941385, PLANO, TX, 75094, US

(21) Appl. No.: 11/111,421

(22) Filed: Apr. 21, 2005

(51) Int. Cl. G06F 15/173

(52) U.S. Cl. 709/238

(57) ABSTRACT

A method and apparatus is presented for distributing data among media servers in a network. Methods implemented in accordance with the teachings of the present invention facilitate load balancing across the network. In one embodiment, a client-side load-balancing method is presented. In a second embodiment, a server-side load-balancing method is presented.

### BACKGROUND OF THE INVENTION

### Description of the Related Art

The information age has made it almost impossible to run a modern business without the use of a computer. With the pervasive spread of computers and networking a large volume of data is now generated and made accessible through computers and communication networks. For example, a simple thing like the email transactions of a multinational corporation generates a voluminous amount of data.

As more data becomes available on networks such as the Internet, issues arise with the transfer and storage of large amounts of data. For example, in video applications, a large volume of data is generated in a very small amount of time. As such, when using a public or private network, the proper bandwidth has to be provided to communicate the data and the appropriate amount of storage has to be provided to store and manipulate the data.

However, providing substantial communications bandwidth and maintaining storage facilities to store data is not trivial. First, there is a tremendous amount of cost associated with both activities. Second, substantial planning is often required to deploy high bandwidth networks or to provide and maintain massive data storage facilities. Lastly, deploying these networks and facilities to address dynamic end-user requirements is almost impossible using conventional methods and approaches.

Purchasing bandwidth from a service provider is very costly. One T1 line may not cost a substantial amount of money, but for a multinational company that is buying many T1, T2, T3, etc. there is a substantial cost. This cost may run into tens and hundreds of millions of dollars per year. In addition, deploying storage facilities to house this data is also very costly. Not only is the purchase of the machines and storage devices costly, but the facilities used to house the machines and storage devices are very costly. Aside from the cost of the real estate and the building, there are very stringent, power requirements, temperature requirements, backup system requirements, etc. that all add to the cost.

Once the initial planning has been accomplished, substantial logistical planning is needed to deploy the required bandwidth and or data storage facilities. Conventional planning could take a year with many man-hours spent on putting the bandwidth and storage facilities in place. In addition, as part of this planning, the short-term and long-term needs of the user population have to be assessed. This includes the application that will be utilized by the end user. For example, text files have different bandwidth and storage requirements than streaming video. Further, if a multinational company plans to grow at ten percent per year, there is a need to build networking and storage capacity that will support the growth in end users.

As is clear from the foregoing, accommodating the communication and storage needs of large data users using conventional methods is not a trivial undertaking. In addition, most conventional methods and network architectures cannot accommodate modern end-user requirements for flexible and dynamic storage.

Thus, there is a need for a cost-effective method and apparatus for storing large amounts of data. There is a need for a method and apparatus for storing large amounts of data that can easily change as end-user requirements change.

### SUMMARY OF THE INVENTION

In accordance with the teachings of the present invention, a method and apparatus is presented for distributing (i.e., cascading) content among media data centers. The content is distributed in a manner that facilitates load balancing across the network. In one embodiment, a method is presented which enables client-side load balancing. In a second embodiment, a method is presented which facilitates load balancing as content is distributed among media data centers (i.e., server-side load balancing).

In addition, the methods operate on a variety of architectures. In one embodiment, the foregoing methods operate in an architecture including a client, a database server, an administration server, a polling server, and media data centers communicating across a public network, such as the Internet. In a second embodiment, the foregoing methods operate in an architecture including a client, a database server, an administration server, a polling server, and media data centers communicating across a private network, such as a virtual private network (VPN). In a third embodiment, the foregoing methods operate in an architecture including a client, a database server, an administration server, a polling server, and media data centers communicating across both a public and a private network. It should be appreciated that a number of permutations and combinations of the foregoing may be implemented and still remain within the scope of the present invention. For example, a number of the components in the architecture may be consolidated or in the alternative, the foregoing methods may operate in networks that include less than all of the components specified above. Lastly, combinations of the foregoing components with public networks, private networks, or a combination of the two may be combined to form architectures that are within the scope of the present invention.

A method of operating a network, comprises the steps of determining a location of content; receiving a list of address associated with the content in response to determining the location of the content; and identifying a first address by randomly selecting an address from the list of addresses associated with the content.

A method of operating a network, comprises the steps of receiving a request for content from a media server; transmitting a list of servers storing the content in response to receiving the request for content from the media server, the media server randomly selecting a target server from the list of servers and downloading the content from the target server; receiving download information identifying that the media server has downloaded the content; and updating the list of servers storing the content to reflect that the media server has downloaded the content.

A method of operating a network, the network comprises a database server, a storing media server, and a requesting media server, the method comprising the steps of: transmitting a request for content across the network from the requesting media server to an database server; receiving a list of address in response to requesting the content, each of the list of addresses associated with a storing media server, each storing media server storing the content; randomly selecting at the requesting media server an address associated with a storing media server from the list of addresses; downloading the content from the storing media server in response to randomly requesting at the requesting media server an address associated with the storing media server; and updating the list of addresses at the requesting media server to reflect an address associated with the requesting media server in response to downloading the content from the storing media server.

### BRIEF DESCRIPTION OF THE DRAWINGS

FIG. 1 displays an architecture implemented in accordance with the teachings of the present invention.

FIG. 2 displays a flow diagram detailing a method of cascading data in the architecture presented in FIG. 1.

FIG. 3 displays a flow diagram detailing a method of cascading data implemented in accordance with the teachings of the present invention.

FIG. 4 displays a flow diagram detailing a method of delivering data implemented in accordance with the teachings of the present invention.

FIG. 5 displays an architecture including VPNs implemented in accordance with the teachings of the present invention.

FIG. 6 displays a computer architecture implemented in accordance with the teachings of the present invention.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

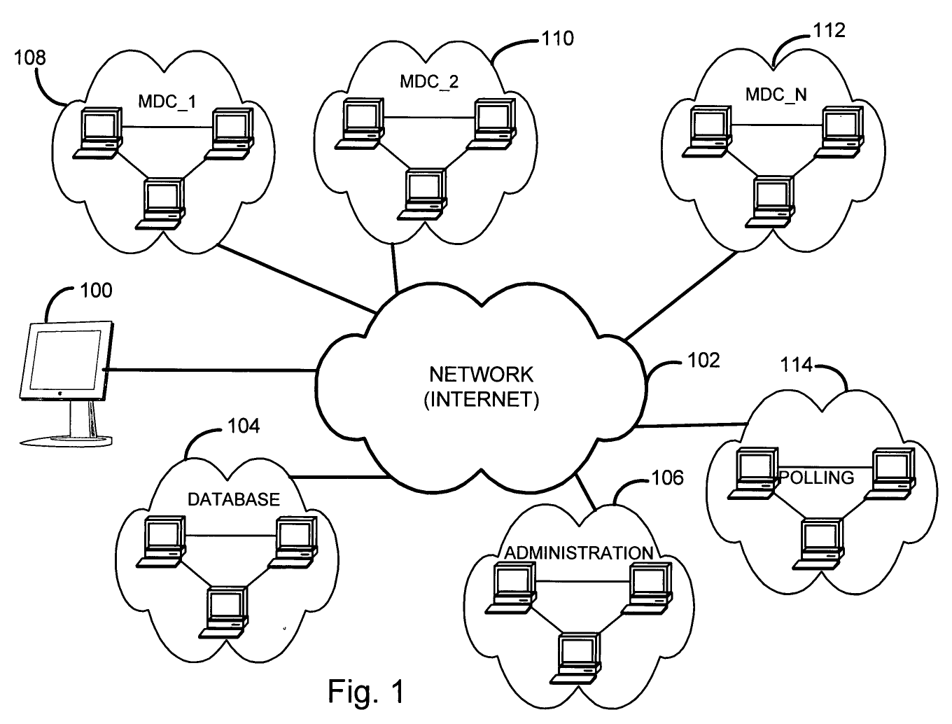

FIG. 1 displays a network architecture implemented in accordance with the teachings of the present invention. A client 100 is displayed. The client 100 may be implemented with a variety of technologies, such as a standard computer or as a computer network. The client 100 is in communication with a network 102. The network 102 may be a public data network or a private data network. A variety of technologies may be used to implement the network 102, such as packets-switched technology, circuit-switched technology, optical technology, wireless technology, etc.

Database servers 104 are in communication with the network 102. The database servers 104 may be implemented as a single database, a distributed database, a database network cluster, etc. The database servers 104 store network information about various components, users, etc. of the network shown in FIG. 1. Administration servers 106 are in communication with the network 102. The administration servers 106 may include a single database, a distributed database, a database network cluster, etc. The administration servers 106 include any device and/or software that is able to receive and store content and/or update database servers 104 as the status of content across the network 102 changes. In one embodiment, the administration servers 106 provide a web interface to the database servers 104 (i.e., function as web servers). For example, the administration servers 106 may be implemented as active server pages. Several media data centers 108, 110, and 112 are also in communication with the network 102. The media data center (MDC_1) 108, the media data center (MDC_2) 110, and the media data center (MDC_N) 112 may each represent a single media data center or a plurality of media data centers. The media data centers (108, 110, 112) may be implemented as a database for storing information, storage media, a network cluster of databases, a network cluster of storage media. Polling servers 114 are shown. The polling servers 114 include any device used for polling components in the network 102. It should be appreciated that client 100, network 102, database servers 104, administration servers 106, polling servers 114 and media data center 108, 110 and 112 are each be implemented with hardware and/or software as a single implementation of hardware and/or software or as a network of hardware and/or software.

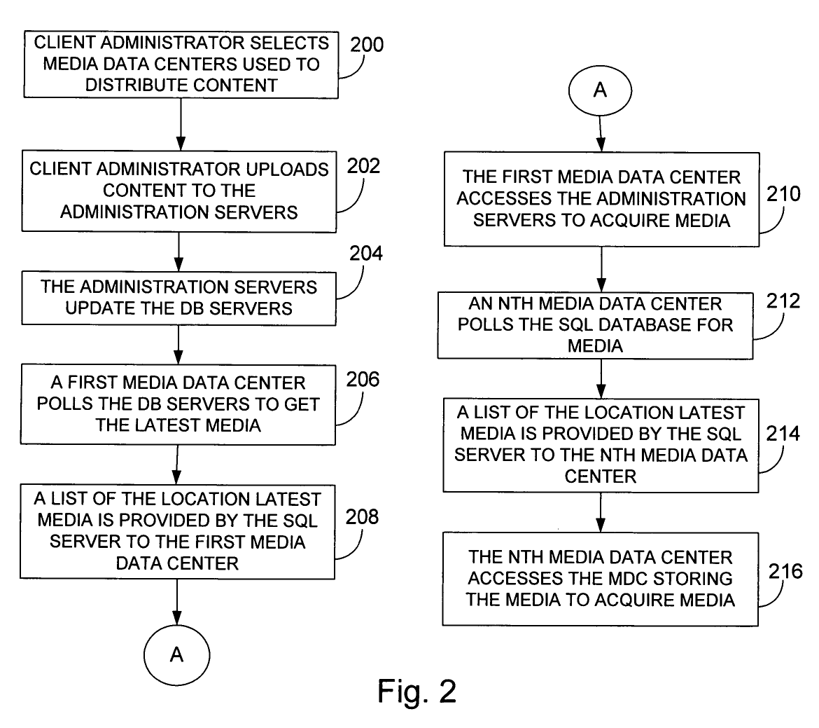

FIG. 2 displays a flow diagram detailing a method of cascading data in the architecture presented in FIG. 1. FIG. 2 will be discussed in conjunction with FIG. 1. In accordance with the teachings of the present invention, server-side load balancing is facilitated using the method detailed in the flow diagram shown in FIG. 2.

At step 200, a client administrator (i.e., end user) operating client 100 selects media data centers (i.e., 108, 110, 112) used to distribute content. The client administrator may operate client 100 to select various media data centers. At step 202, a client administrator operating client 100 uploads content to the administration servers 106. At step 204, the administration servers 106 update the database servers 104 specifying that the administration servers 106 have received new content. At step 206, a first media data center (108, 110, 112) polls the database servers 104 to receive content. The first media data center (108, 110, 112) to poll for content may be any of the media data centers (108, 110, or 112). For the purposes of description, lets assume that media data center (108) is the first media data center to poll database servers 104 for content. At step 208, the database servers 104 provide a list of the locations in the network 102 storing the latest content to the media data center 108 (i.e., first media data center) in response to the polling by the first media data center 108.

In one embodiment, the location of the media data centers (108, 110, 112) may be implemented with an Internet Protocol (IP) address. Therefore, the list of location may include a list of IP addresses associated with the media data centers (108, 110, 112) that store the latest content. In a second embodiment, the list of the latest content also includes a label associated with the content. As such, the polling media data center (i.e., media data center 108 in our example) is able to match the list of content (i.e., match the labels) to a list of content that the media data center 108 has already stored to determine if there is a need to download any new content.

Table I, provided below, details the content of a file stored on the database servers 104:

TABLE I

| Address | Content | Time Stamp | Type | Access |
|---|---|---|---|---|
| 123.XX.XX.XX | . . . | . . . | . . . | . . . |

Table I details an “Address” field associated with one of the media data centers (108, 110,112) and/or the administration servers 106. The “Content” field provides a name or label of the content. The “Time Stamp” field details the time that the content was stored. The “Type” field may be used to detail the type of content, such as executable files, password, text, etc. The “Access” field may detail the access privileges associated with the file or the owner of the file. It should be appreciated that a variety of different types of information may be stored in the database servers 104 and as a result, will be accessible. When polled, the database servers 104 will format the information into a file and distribute the information to the polling device. It should be noted that the addresses will correspond to the number of media devices and/or administration devices that store the content. Therefore, if the content may be found in ten locations, in one embodiment, ten addresses will be listed.

Since, in our hypothetical, the media data center 108 is the first media data center to poll when the system is originally configured, the content is stored on the administration servers 106. As a result, the media data center 108 receives a list of IP addresses associated with the administration servers 106 as stated at 210. The first media data center 108 is then able to retrieve the content from the administration servers 106.

During subsequent operation of the network shown in FIG. 1, an nth media data center, such as media data center 112, may poll the database servers 104 for content as shown in step 212. When the nth media data center polls the database servers 104 for content, the content may have already been distributed to other media data centers, such as media data centers 108, 110, and 112. As such, at step 214, the database servers 104 deliver a list of the locations of the latest content to the nth media data center 112. In one embodiment, the list includes the new content that is available in the network 102 and the locations of the new content in the network 102. Therefore, the list may include several IP addresses. For example, if media data center 108, media data center 110, media data center 112, and administration servers 106 have the new content, then the IP addresses associated with these three servers would be included in the list provided to the nth media data center 112.

In accordance with the teachings of the present invention, the nth media data center 112 may then perform a variety of methods to select an appropriate media data center. In one embodiment, the nth media data center 112 randomly selects a number from the list of media data centers. For example, using a pseudo-random number generator operating on the nth media data center 112, a pseudo-random number may be generated and associated with each IP address. The nth media data center 112 may then select one of the IP addresses based on the pseudo-random number. In a second embodiment, a round robin approach may be implemented. For example, if the media data centers are organized in the list in a First-In, First-Out (FIFO) or Last-in, First-Out (LIFO) order, a random selection of media data centers may be achieved using a round robin approach. As stated at 216, the Nth media data center accesses the media data center storing the media (i.e., content) to access the media.

It should be appreciated that a variety of techniques may be implemented to randomly select the media data centers. In accordance with the teachings of the present invention, the random selection of the IP addresses results in load balancing across the network 102. Since the media data centers are selected randomly, no single media data center is utilized more heavily than the others and as a result, the acquisition of data across the media data centers is load balanced over time.

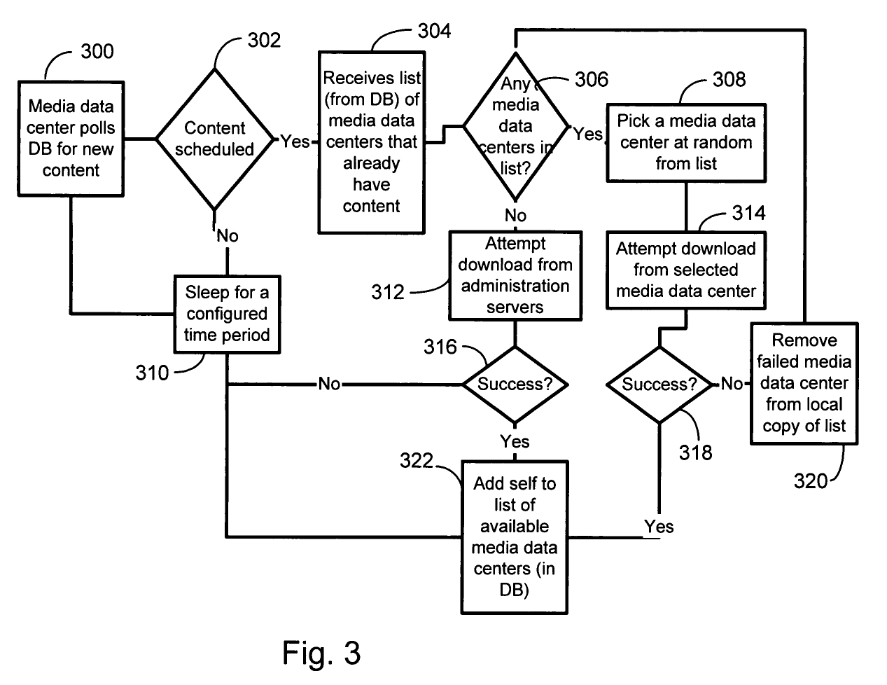

FIG. 3 displays a flow diagram detailing a method of cascading content throughout a network. FIG. 3 will be discussed in conjunction with FIG. 1. At 300, a media data center, such as media data center 108, 110, or 112, poll the database servers 104 for new content. In one embodiment, the database servers 104 may maintain a time stamp that details the specific time that a media data center is supposed to receive content. In one embodiment, the time stamp may indicate a delay until the next poll; therefore, instead of poll at 3:00 p.m., the time stamp may signify polling in the next three hours. Further, in another embodiment, the media data centers themselves would randomly select the delay between each poll.

In accordance with the teachings of the present invention, in one embodiment, load balancing is achieved by staggering the times that content is downloaded to a media data center. For example, a time stamp may be generated and associated with every media data center address in a relational database stored in the database servers 104. As such, each media data center may access data at a staggered time relative to each other and as a result, load balancing is achieved across the media data center.

At step 302, a test is made to determine whether it is time for the specific media data center polling the database servers 104 to receive content. If it is not time for the media data center polling the database severs 104 to receive the content, then as shown at 310, the media data center will sleep for a period of time and then step 300 is performed again. If it is the scheduled time for the media data center to poll for scheduled content, then the database servers 104 provide the media data center with a list of media data centers that already have the content as shown at 304. At 306, the media data center receiving the list makes an inquiry to determine if there are any media data centers on the list. If there are no media data centers on the list, this means that the polling media data center is the first media data center to poll for this new content and as a result, the new content is located on the administration servers 106. Therefore, at 312, an attempt is made to download the content from the administration servers 106. A test is then made to determine if the downloading was successful as stated at 316. If the downloading was not successful, then the media data center sleeps for a configured amount of time as stated at 310. If the download was successful, then the media data center adds its address to the list of available media data centers in the database servers 104 as stated at 322.

If there are media data centers on the list, then at 308 a media data center is picked at random using techniques, such as round robin techniques, LIFO, FIFO, or probability based techniques, such as techniques based on pseudo-random number generators, etc. At 314, an attempt is made to download content from the selected media data center. At 318, if the download is successful, then the media data center adds its address to the list of media data centers that have the content in the database servers 104 as stated at 322. If the download is not successful, then at 320, the media data center is removed from the local copy of the list (i.e., the copy of the list communicated to the media data center) and at 306, the process loops backs to test if there are any other media data centers on the list.

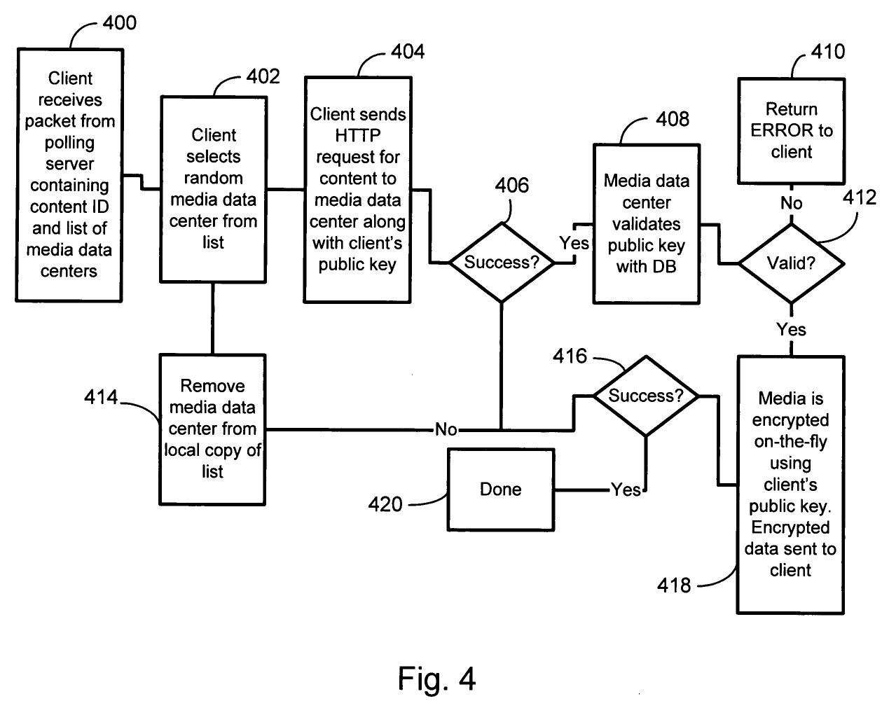

FIG. 4 displays a flow diagram detailing a client delivery method implemented in accordance with the teachings of the present invention. FIG. 4 will be discussed in conjunction with FIG. 1. In accordance with the teachings of the present invention, the method detailed in the flow diagram of FIG. 4 is used to implement client-side load balancing. During operation, after the media has been cascaded out across the network and is resident on various media data centers, a client may request and receive content from the media data centers. At 400, a client receives a packet from a polling server containing a content ID and a list of media data centers. At 402, the client selects a random media data center from the list. At 404, the client sends an HTTP request for content to the media data center along with the client's public key. At 406, a test is made to determine if the request was successful. If the request is not successful at 414, the media data center is removed from the local copy of the list (i.e., copy that is resident at the polling server). If the request is successful, the media data center validates the public key with the database servers 104 as stated at 408. A test is made to determine if the validation is successful as shown by 412. If the validation is not successful, then an error is returned to the client as shown at 410. If the validation is successful, then at 418, media is encrypted on the fly using the client's public key. Encrypted data is then sent to the client. If the encrypted data is successfully sent to the client as shown at 416, then the process is done as stated at 420. If the encrypted data is not successfully sent to the client as tested at 416, then the media data center is removed from the local copy of the list as stated at 414.

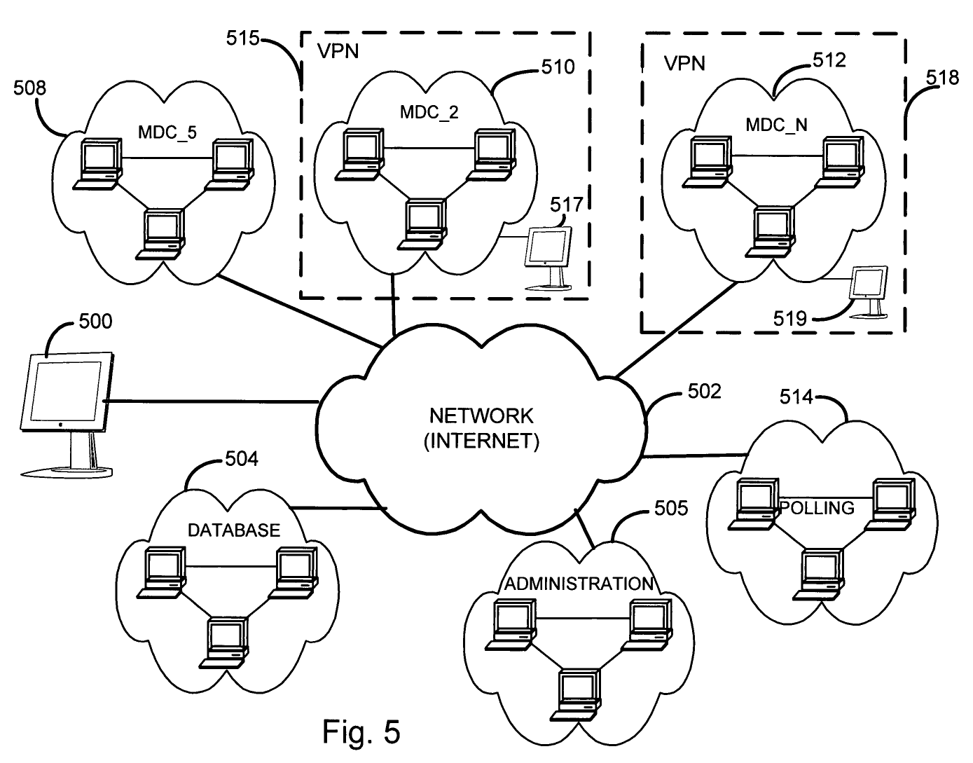

FIG. 5 displays a network architecture implemented in accordance with the teachings of the present invention. A client 500 is displayed. The client 500 is in communication with a network 502. The network 502 may be a public data network or a private data network. A variety of technologies may be used to implement the network 502, such as packets-switched technology, circuit-switched technology, optical technology, wireless technology, etc. Database servers 504 are in communication with the network 502. The database servers 504 store network information about various components of the network 502 shown in FIG. 5. Administration servers 505 are in communication with the network 502. Several media data centers 508, 510, and 512 are also in communication with the network 502. Each media data center (508, 510, 512) may represent any number of media data centers. Media data center 510 is deployed in VPN 515 and media data center 512 is deployed in VPN 518.

During operation, a client administrator may operate client 500 to upload content to an administration server 505. The administration server 505 updates the database servers 504 specifying that the administration server 505 has received new content. A first media data center polls the database servers 504 to receive content. The first media data center to poll for media may be any of the media data centers 508, 510, or 512. For example, lets assume that media data center 508 is the first media data center and polls database servers 504 for media. A list of the locations of the latest media is provided by the database servers 504 to the media data center 508 (i.e., first media data center) in response to the polling by the first media data center 508. In one embodiment, the location of the media data center may be identified with an Internet protocol (IP) address. Therefore, the list of locations may include a list of IP addresses of the media data centers that have the latest content. In addition, the list of locations of the latest media may also include a label associated with the new content. As such, the polling media data center is able to match the list of content (i.e., match the labels) to the content already stored in the media data center to determine if there is a need to download any new content.

Since the media data center 508 is the first media data center to poll when the system is originally configured, the content is stored on the administration servers 505. As a result, the media data center 508 receives a list of an IP address associated with the administration servers 505 where the content is stored. The first media data center 508 is then able to retrieve the content from the administration servers 505.

During later operation of the network 502 shown in FIG. 5, an nth media data center, such as media data center 512, may poll the database servers 504 for content. When the nth media data center 512 polls the database servers 504 for content, the content may have already been distributed to other media data centers, such as media data centers 508 and 510. As such, at step 514, the database servers 504 deliver a list of the locations of the latest content to the nth media data center 512. The list includes all of the new content that is available in the network 502 and the locations of the new content in the network 502. Therefore, the list may contain several IP addresses. For example, if media data center 508, media data center 510, and administration servers 505 have the new content, then the IP addresses of these three servers would be included in the list provided to the nth media data center 512. The nth media data center 512 may then perform a variety of methods to select an appropriate media data center. In one embodiment, the nth media data center 512 randomly selects a number from the list of media data centers. For example, using a pseudo-random number generator operating on the nth media data center 512, a pseudo-random number may be generated and associated with each IP address. The nth media data center 512 may then select one of the IP addresses based on the pseudo-random number. In a second embodiment, a round robin approach may be implemented. For example, if the new media is organized in the list in a FIFO or LIFO order, a random selection of media data centers may be achieved.

It should be appreciated that a variety of techniques may be implemented to randomly select the media data centers. In accordance with the teachings of the present invention, the random selection of the IP addresses results in load balancing across the network 502. Since the media data centers are selected randomly, no single media data center is utilized more heavily than the others and as a result, the acquisition of data across the media data centers is load balanced over time.

Since media data centers 510 and 512 are positioned within VPNs (515, 518), the network 502 shown in FIG. 5 may be configured so that the clients (517, 519) within the VPNs (515, 518) may only have exposure to media data centers within their respective VPNs (515, 518). For example, database servers 504 may be configured so that client 517 may only have exposure to media data center 510. As such, the list of media data centers sent to client 517 may only include the media data centers within VPN 515. In a similar manner, database servers 504 may be configured so that client 519 may only have exposure to media data center 512. As such, the list of media data centers sent to client 519 may only include the media data centers within VPN 518. Using this approach, client 517 would not be aware of media data center 512 and client 519 would not be aware of media data center 510.

In an alternate embodiment, database servers 504 may be configured so that client 517 may have exposure to media data center 510 and media data center 508. As such, the list of media data centers sent to client 517 may only include the media data centers within VPN 515 (i.e., private network) and the media data center 508 connected to the Internet (i.e., public network). In a similar manner, database servers 504 may be configured so that client 519 may have exposure to media data center 512 and media data center 508. As such, the list of media data centers sent to client 519 may include the media data centers within VPN 518 and the media data center 508 connected to the network 502 (i.e., public network). Using this approach, client 517 would not be aware of media data center 512, but would be aware of media data center 508 and client 519 would not be aware of media data center 510, but would also be aware of media data center 508. It should also be appreciated that a number of permutations and combinations of the foregoing may be implemented and still remain within the scope of the present invention.

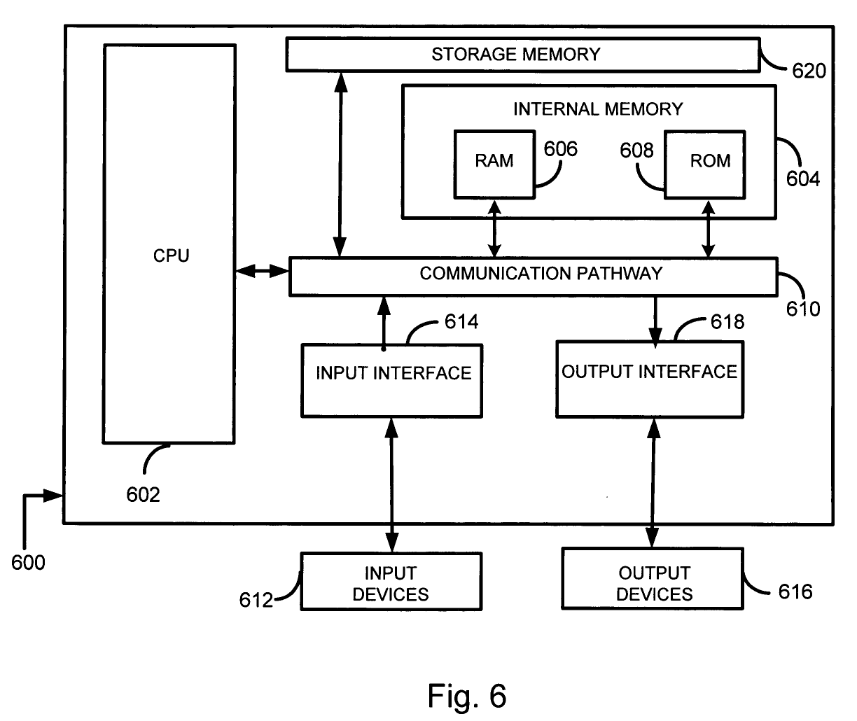

FIG. 6 displays a hardware architecture implementing the teachings of the present invention. The computer 600 may be used to implement the client 100, network 102, database servers 104, administration servers 106, polling servers 114, or a media data center 108, 110, or 112 of FIG. 1. A central processing unit (CPU) 602 functions as the brain of the computer 600. Internal memory 604 is shown. The internal memory 604 includes short-term memory 606 and long-term memory 608. The short-term memory 606 may be a Random Access Memory (RAM) or a memory cache used for staging information. The long-term memory 608 may be a Read Only Memory (ROM) or an alternative form of memory used for storing information. Storage memory 620 may be any memory residing within the computer 600 other than internal memory 604. In one embodiment of the present invention, storage memory 620 is implemented with a hard drive. A communication pathway 610 is used to communicate information within computer 600. In addition, the communication pathway 610 may be connected to interfaces, which communicate information out of the computer 600 or receive information into the computer 600.

Input devices, such as tactile input device, joystick, keyboards, microphone, communications connections, or a mouse, are shown as 612. The input devices 612 interface with computer 600 through an input interface 614. Output devices, such as a monitor, speakers, communications connections, etc., are shown as 616. The output devices 616 communicate with computer 600 through an output interface 618.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A method of operating a network, comprising the steps of:
(a) determining a location of content;
(b) receiving a list of address associated with the content in response to determining the location of the content; and
(c) identifying a first address by randomly selecting an address from the list of addresses associated with the content.

2. A method of operating a network, as set forth in claim 1, further comprising the step of retrieving the content from the first address.

3. A method of operating a network as set forth in claim 1, wherein the list of addresses associated with the content are Internet protocol address.

4. A method of operating a network as set forth in claim 1, wherein each address in the list of addresses is associated with a media server.

5. A method of operating a network as set forth in claim 1, wherein the list of addresses is received across a public network.

6. A method of operating a network as set forth in claim 1, wherein each address in the list of addresses is accessible across a public network.

7. A method of operating a network as set forth in claim 1, wherein a selected number of the list of addresses is accessible across a virtual private network.

8. A method of operating a network as set forth in claim 1, wherein the step of randomly selecting includes the step of selecting based on a pseudo-random number generation.

9. A method of operating a network as set forth in claim 1, wherein the step of determining the location of content includes requesting location of the content and receiving the list of addresses associated with the content in response to requesting the location of the content.

10. A method of operating a network as set forth in claim 1, further comprising the step of performing load-balancing in response to randomly selecting and address from the list of addresses.

11. A method of operating a network as set forth in claim 2, wherein the list is provided by a database server.

12. A method of operating a network as set forth in claim 2, wherein the step of retrieving is performed from a media server.

13. A method of operating a network as set forth in claim 2, further comprising the step of adding an address associated with a media server performing steps (a) through (c), to the list of addresses.

14. A method of operating a network as set forth in claim 1, wherein the method is performed in a client machine.

15. A method of operating a network as set forth in claim 1, wherein the method is performed in a media server.

16. A method of operating a network, comprising the steps of:
receiving a request for content from a media server;
transmitting a list of servers storing the content in response to receiving the request for content from the media server, the media server randomly selecting a target server from the list of servers and downloading the content from the target server;
receiving download information identifying that the media server has downloaded the content; and
updating the list of servers storing the content to reflect that the media server has downloaded the content.

17. A method of operating a network as set forth in claim 16, wherein load-balancing is achieved across the network in response to the method.

18. A method of operating a network as set forth in claim 16, wherein the method is performed in a database server.

19. A method of operating a network, the network comprising a database server, a storing media server, and a requesting media server, the method comprising the steps of:
transmitting a request for content across the network from the requesting media server to an database server;
receiving a list of address in response to requesting the content, each of the list of addresses associated with a storing media server, each storing media server storing the content;
randomly selecting at the requesting media server an address associated with a storing media server from the list of addresses;
downloading the content from the storing media server in response to randomly requesting at the requesting media server an address associated with the storing media server; and
updating the list of addresses at the requesting media server to reflect an address associated with the requesting media server in response to downloading the content from the storing media server.

20. A method of operating a network, as set forth in claim 19 further comprising an administration server, the administration server functioning as a gateway for deploying content in the network.
